(19) United States
(12) Patent Application Publication
(10) Pub. No.: US 2024/0288155 A1
(43) Pub. Date: Aug. 29, 2024

(54) ILLUMINATION DEVICE

(71) Applicant: Japan Display Inc., Tokyo (JP)

(72) Inventors: Masashi TAKAHATA, Tokyo (JP); Koichi NAGAO, Tokyo (JP)

(21) Appl. No.: 18/656,142

(22) Filed: May 6, 2024

Related U.S. Application Data
(63) Continuation of application No. PCT/JP2022/033373, filed on Sep. 6, 2022.

(30) Foreign Application Priority Data
Nov. 8, 2021 (JP) 2021-181834

(51) Int. Cl. F21V 29/61; F21V 9/40; F21V 29/503; F21V 29/508; F21V 29/67; F21Y 115/10

(52) U.S. Cl. CPC F21V 29/61; F21V 9/40; F21V 29/503; F21V 29/508; F21V 29/67; F21Y 2115/10

(57) ABSTRACT

According to an aspect, an illumination device includes: a light source configured to emit light; a light distributor including a liquid crystal panel and configured to adjust a light distribution region of light externally emitted from the light source by controlling transmittance and a transmission region of light passing through the liquid crystal panel; a temperature information acquirer configured to acquire information indicating temperature of the light distributor; and a controller configured to perform predetermined operation for preventing or reducing increase in the temperature of the light distributor when the temperature of the light distributor is equal to or higher than a predetermined temperature.

### CROSS-REFERENCE TO RELATED APPLICATION

This application claims the benefit of priority from Japanese Patent Application No. 2021-181834 filed on Nov. 8, 2021 and International Patent Application No. PCT/JP2022/033373 filed on Sep. 6, 2022, the entire contents of which are incorporated herein by reference.

### BACKGROUND

### 1. Technical Field

What is disclosed herein relates to an illumination device.

### 2. Description of the Related Art

As described in Japanese Patent Application Laid-open Publication No. 2021-122262 (JP-A-2021-122262), it is known that there is an illumination device the orientation of which is changeable so that the emission region of light can be changed.

In the illumination device disclosed in JP-A-2021-122262, a movable component and a driver need to be provided so that the orientation of a light source can be changed. With such a configuration, the size of the illumination device unavoidably increases and a space in which operation of the illumination device is allowed is needed around the illumination device. Therefore, it is difficult to employ the configuration, depending on an installation condition of the illumination device.

Thus, a configuration has been considered in which a liquid crystal panel is provided on the emission path of light emitted from a light source to control the transmission region and transmission degree of the light in the liquid crystal panel so that light distribution control can be more flexibly performed. However, the liquid crystal panel has a limited temperature range in which the liquid crystal panel normally operates, and thus measures are needed in case the temperature of the liquid crystal panel reaches a high temperature out of the temperature range.

For the foregoing reasons, there is a need for an illumination device capable of preventing or reducing temperature increase of a liquid crystal panel provided on the emission path of light from a light source.

### SUMMARY

According to an aspect, an illumination device includes: a light source configured to emit light; a light distributor including a liquid crystal panel and configured to adjust a light distribution region of light externally emitted from the light source by controlling transmittance and a transmission region of light passing through the liquid crystal panel; a temperature information acquirer configured to acquire information indicating temperature of the light distributor; and a controller configured to perform predetermined operation for preventing or reducing increase in the temperature of the light distributor when the temperature of the light distributor is equal to or higher than a predetermined temperature.

### BRIEF DESCRIPTION OF THE DRAWINGS

FIG. 1 is a schematic diagram illustrating a main configuration of an illumination device;

FIG. 2 is a schematic diagram illustrating an exemplary configuration of a light distributor and an exemplary positional relation between a temperature sensor and a plurality of liquid crystal panels included in the light distributor;

FIG. 3 is a perspective view of a light control panel according to an embodiment;

FIG. 4 is a plan view illustrating wiring of an array substrate according to the embodiment when viewed from above;

FIG. 5 is a plan view illustrating wiring of a counter substrate according to the embodiment when viewed from above;

FIG. 6 is a plan view illustrating wiring of the light control panel according to the embodiment when viewed from above;

FIG. 7 is a sectional view along line V-V in FIG. 6;

FIG. 8 is a schematic diagram illustrating an example of mounting the temperature sensor on the liquid crystal panel;

FIG. 9 is a schematic diagram illustrating an exemplary configuration of a temperature sensor provided integrally with a liquid crystal panel;

FIG. 10 is a schematic diagram illustrating exemplary acquisition regions of temperature information in the liquid crystal panel;

FIG. 11 is a schematic diagram illustrating a main configuration of the temperature sensor and a control device;

FIG. 12 is a diagram illustrating a voltage divider circuit including a temperature detection resistance element and a reference resistance element;

FIG. 13 is a schematic diagram illustrating exemplary operation control performed as temperature increase suppression control;

FIG. 14 is a block diagram illustrating an exemplary main configuration of a system substrate;

FIG. 15 is a flowchart of the operation processing of the illumination device;

FIG. 16 is a flowchart of an exemplary process of temperature increase suppression processing (step S7) illustrated in FIG. 15;

FIG. 17 is a time chart illustrating the relation between operation of the liquid crystal panel and a temperature measurement period;

FIG. 18 is a flowchart of an exemplary process of the temperature increase suppression processing (step S7) illustrated in FIG. 15;

FIG. 19 is a flowchart of an exemplary process of the temperature increase suppression processing (step S7) illustrated in FIG. 15; and

FIG. 20 is a table indicating an exemplary correspondence relation between a temperature measured in processing at step S5, a space between a reflector and the light distributor provided with the temperature sensor, rotation speed of a fan, and light emission intensity of a light source.

### DETAILED DESCRIPTION

Embodiments of the present disclosure will be described below with reference to the accompanying drawings. What is disclosed herein is merely exemplary, and any modification that could be easily thought of by the skilled person in the art as appropriate without departing from the gist of the invention is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

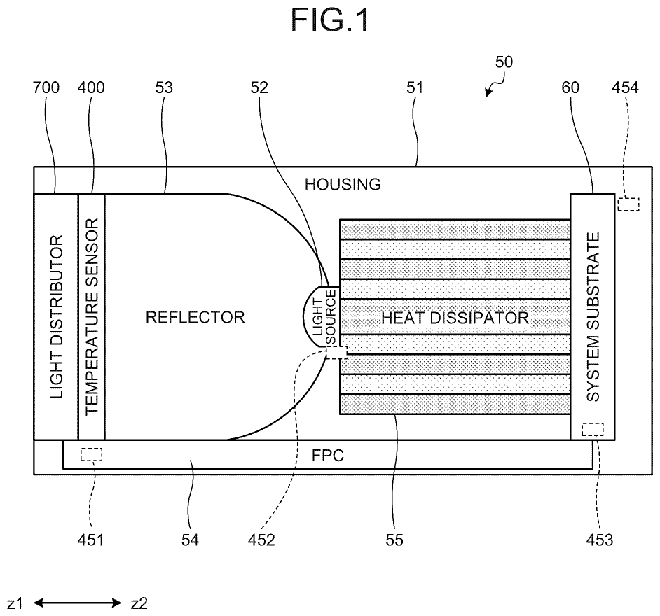

FIG. 1 is a schematic diagram illustrating a main configuration of an illumination device 50. The illumination device 50 includes a housing 51, a light source 52, a reflector 53, a light distributor 700, a temperature sensor 400, flexible printed circuits (FPC) 54, a system substrate 60, and a heat dissipator 55. The housing 51 is a housing that houses the light source 52, the reflector 53, the light distributor 700, the temperature sensor 400, the FPC 54, the system substrate 60, and the heat dissipator 55. The housing 51 is desirably made of a material (for example, aluminum) with excellent heat dissipation properties.

The light source 52 emits light in accordance with electric power supply. The light source 52 is, for example, a light emitting diode (LED) but may be an electric light of any other form.

The reflector 53 guides light emitted from the light source 52 to the light distributor 700. In description of the reflector 53, the light distributor 700 side relative to the reflector 53 is referred to as a z1 direction side, and the light source 52 side relative to the reflector 53 is referred to as a z2 direction side. A facing direction of the z1 direction side and the z2 direction side is referred to as a z direction. The reflector 53 is an optical member having an opening width that broadens in a conical shape toward the z1 direction side from the z2 direction side on which the light source 52 is positioned, in a plan view as viewing in a direction orthogonal to the z direction. The reflector 53 guides light emitted from the light source 52 to the light distributor 700 by refraction through a prism or the like or mirrored fabrication of the inner peripheral surface of the conical shape.

The light distributor 700 is provided to enable change of the transmission degree and transmission region of light emitted from the light source 52 and the transmission degree and transmission region of light emitted from the light source 52 and guided by the reflector 53. The temperature sensor 400 functions as a temperature information acquirer that acquires information related to the temperature of the light distributor 700.

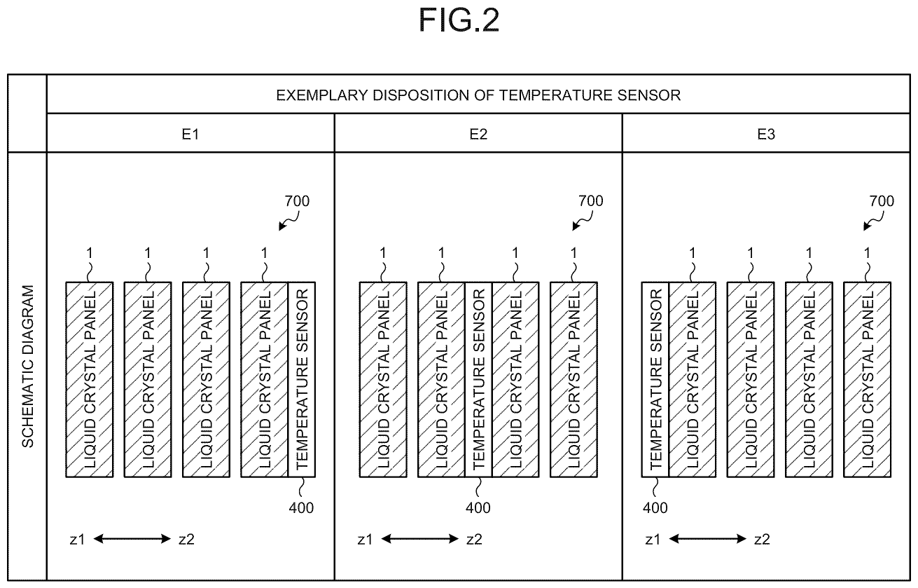

FIG. 2 is a schematic diagram illustrating an exemplary configuration of the light distributor 700 and an exemplary positional relation among the temperature sensor 400 and a plurality of liquid crystal panels 1 included in the light distributor 700. As illustrated in FIG. 2, the light distributor 700 includes the liquid crystal panels 1 arranged in the z direction. In Examples E1, E2, and E3 in FIG. 2, the light distributor 700 including four liquid crystal panels 1 is illustrated. As illustrated in Example E1, the temperature sensor 400 may be provided on the z2 direction side of the liquid crystal panel 1 positioned closest to the z2 direction side among the liquid crystal panels 1 included in the light distributor 700. As illustrated in Example E2, the temperature sensor 400 may be provided between two of the liquid crystal panels 1 included in the light distributor 700. As illustrated in Example E3, the temperature sensor 400 may be provided on the z1 direction side of the liquid crystal panel 1 positioned closest to the z1 direction side among the plurality of liquid crystal panels 1 included in the light distributor 700.

In the case of Example E1, the temperature sensor 400 can more quickly and easily sense increases in the temperature of the light distributor 700 caused by, in some cases, radiation heat from components provided on the z2 direction side relative to the light distributor 700. The components provided on the z2 direction side relative to the light distributor 700 are the light source 52 and circuits provided on the system substrate 60 to be described later. In the case of Example E3, under an environment with such a high temperature (equal to or higher than a predetermined temperature to be described later, for example) that air outside the illumination device 50 affects operation of the light distributor 700, the temperature sensor 400 can more quickly and easily sense increases in the temperature of the light distributor 700 due to the environment. The case of Example E2 is not specialized for any of the cases of Examples E1 and E3 described above but can handle both cases.

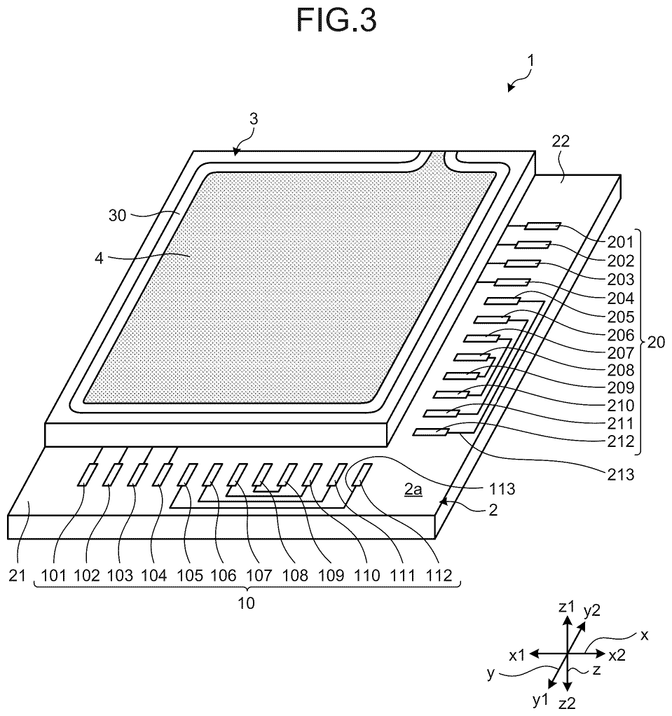

Each liquid crystal panel 1 included in the light distributor 700 will be described below with reference to FIGS. 3 to 7.

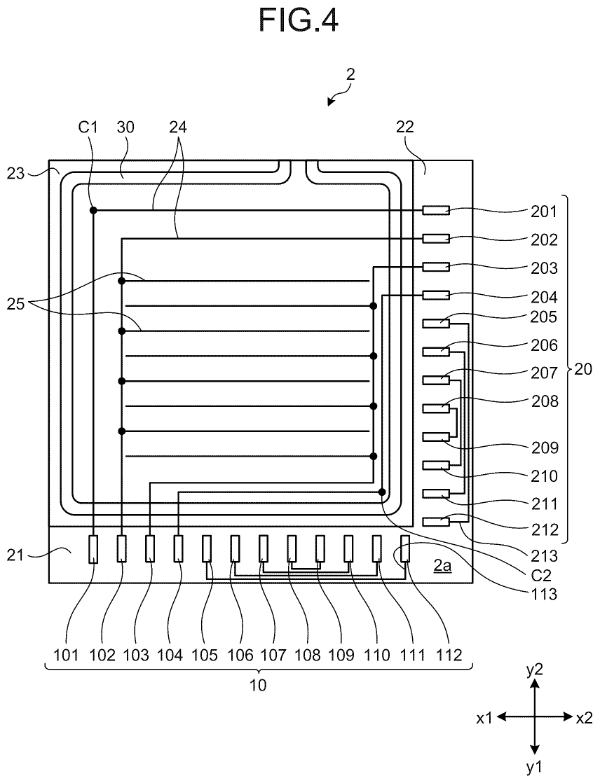

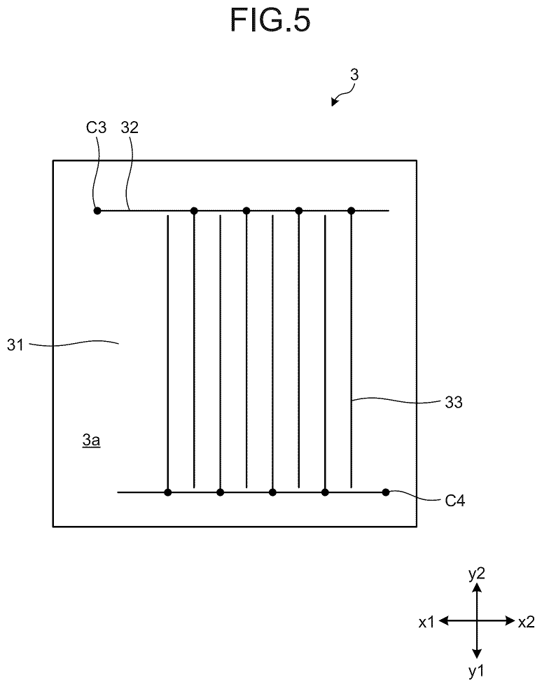

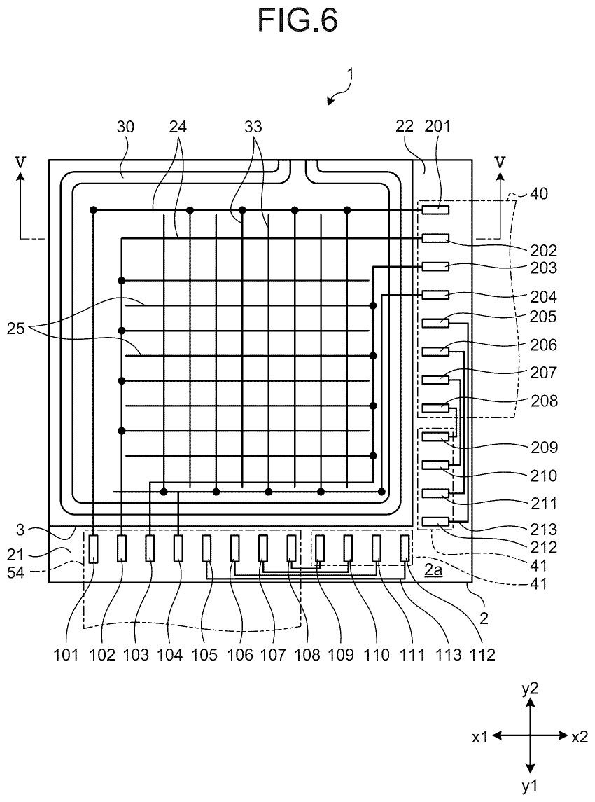

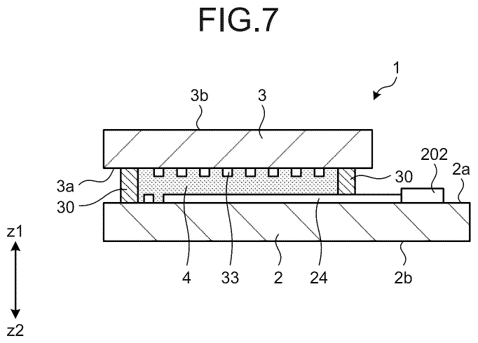

FIG. 3 is a perspective view of a light control panel according to an embodiment. FIG. 4 is a plan view illustrating wiring of an array substrate according to the embodiment when viewed from above. FIG. 5 is a plan view illustrating wiring of a counter substrate according to the embodiment when viewed from above. FIG. 6 is a plan view illustrating wiring of the light control panel according to the embodiment when viewed from above. FIG. 7 is a sectional view along line V-V in FIG. 6. Note that, in an xyz coordinate system illustrated in FIGS. 3 to 6, a direction along an x1 direction and an x2 direction is referred to as an x direction. The x1 direction is opposite to the x2 direction. A direction along a y1 direction and a y2 direction is referred to as a y direction. The y1 direction is opposite to the y2 direction. The x direction is orthogonal to the y direction. A plane along the x direction and the y direction is orthogonal to the z direction.

As illustrated in FIG. 3, each liquid crystal panel 1 includes an array substrate 2, a counter substrate 3, a liquid crystal layer 4, and a seal member 30.

As illustrated in FIGS. 3 and 6, the array substrate (first substrate) 2 is larger than the counter substrate (second substrate) 3. In other words, the area of the counter substrate (second substrate) 3 is smaller than the area of the array substrate (first substrate) 2. The array substrate 2 includes a transparent glass 23 (refer to FIG. 4). The counter substrate 3 includes a transparent glass 31 (refer to FIG. 5). In the embodiment, the array substrate 2 and the counter substrate 3 each have a square shape in a plan view from above, but the shape of each substrate according to the present invention is not limited to a square shape. A first terminal group area 21 and a second terminal group area 22 are provided on a front surface 2a of the array substrate 2. The first terminal group area 21 is positioned at an end part of the front surface 2a of the array substrate 2 on the y1 side. The second terminal group area 22 is positioned at an end part of the front surface 2a of the array substrate 2 on the x2 side. The first terminal group area 21 and the second terminal group area 22 form an L shape when viewed from above. A first terminal group 10 is disposed in the first terminal group area 21, and a second terminal group 20 is disposed in the second terminal group area 22. Since the area of the counter substrate 3 is smaller than the area of the array substrate 2, the first terminal group 10 and the second terminal group 20 are exposed. The first terminal group 10 and the second terminal group 20 are also simply referred to as terminal portions.

As illustrated in FIGS. 3 and 6, the first terminal group 10 includes a first terminal 101, a second terminal 102, a third terminal 103, a fourth terminal 104, a first pad 105, a second pad 106, a third pad 107, a fourth pad 108, a fifth pad 109, a sixth pad 110, a seventh pad 111, and an eighth pad 112. The first terminal 101, the second terminal 102, the third terminal 103, the fourth terminal 104, the first pad 105, the second pad 106, the third pad 107, the fourth pad 108, the fifth pad 109, the sixth pad 110, the seventh pad 111, and the eighth pad 112 are sequentially arranged in a right-left direction from the x1 side toward the x2 side. The first pad 105 and the eighth pad 112 are electrically coupled to each other through a lead line 113. The second pad 106 and the seventh pad 111 are electrically coupled to each other through a lead line 113. The third pad 107 and the sixth pad 110 are electrically coupled to each other through a lead line 113. The fourth pad 108 and the fifth pad 109 are electrically coupled to each other through a lead line 113.

As illustrated in FIGS. 3 and 6, the second terminal group 20 includes a fifth terminal 201, a sixth terminal 202, a seventh terminal 203, an eighth terminal 204, a ninth pad 205, a tenth pad 206, an eleventh pad 207, a twelfth pad 208, a thirteenth pad 209, a fourteenth pad 210, a fifteenth pad 211, and a sixteenth pad 212. The fifth terminal 201, the sixth terminal 202, the seventh terminal 203, the eighth terminal 204, the ninth pad 205, the tenth pad 206, the eleventh pad 207, the twelfth pad 208, the thirteenth pad 209, the fourteenth pad 210, the fifteenth pad 211, and the sixteenth pad 212 are sequentially arranged in a front-back direction from the y2 side toward the y1 side. The ninth pad 205 and the sixteenth pad 212 are electrically coupled to each other through a corresponding one of lead lines 213. The tenth pad 206 and the fifteenth pad 211 are electrically coupled to each other through a corresponding one of the lead lines 213. The eleventh pad 207 and the fourteenth pad 210 are electrically coupled to each other through a corresponding one of the lead lines 213. The twelfth pad 208 and the thirteenth pad 209 are electrically coupled to each other through a corresponding one of the lead lines 213.

As illustrated in FIG. 3, the counter substrate 3 is disposed on an upper side (z1 side) relative to the array substrate 2. The seal member 30 and the liquid crystal layer 4 are provided between the counter substrate 3 and the array substrate 2. The seal member 30 is provided in an annular shape along the outer periphery of the counter substrate 3, and the inside of the seal member 30 is filled with the liquid crystal layer 4. A region in which the liquid crystal layer 4 is provided is an active region, the outside of the liquid crystal layer 4 is a frame region, and the first terminal group area 21 and the second terminal group area 22 are terminal regions.

The following describes wiring on the array substrate 2 and the counter substrate 3. As illustrated in FIG. 7, wiring is provided on a front surface of each substrate. In other words, a surface on which wires are provided is referred to as the front surface, and a surface opposite to the front surface is referred to as the back surface. Specifically, as illustrated in FIG. 7, of the front surface 2a and a back surface 2b of the array substrate 2, the front surface 2a on the upper side is provided with wiring; whereas, of a front surface 3a and a back surface 3b of the counter substrate 3, the front surface 3a on the lower side is provided with wiring. In this manner, the front surface 2a of the array substrate 2 and the front surface 3a of the counter substrate 3 are disposed facing each other with the liquid crystal layer 4 interposed therebetween.

As illustrated in FIG. 4, wiring lines 24 and first electrodes 25 are provided on the front surface 2a of the transparent glass 23 of the array substrate 2. Specifically, the first terminal 101 and the fifth terminal 201 are electrically coupled to each other through a corresponding one of the wiring lines 24. The second terminal 102 and the sixth terminal 202 are electrically coupled to each other through a corresponding one of the wiring lines 24. The third terminal 103 and the seventh terminal 203 are electrically coupled to each other through a corresponding one of the wiring lines 24. The fourth terminal 104 and the eighth terminal 204 are electrically coupled to each other through a corresponding one of the wiring lines 24. More than one of the first electrodes 25 are coupled to the wiring line 24 connecting the second terminal 102 and the sixth terminal 202. More than one of the first electrodes 25 are coupled to the wiring line 24 connecting the third terminal 103 and the seventh terminal 203. The wiring lines 24 are provided with couplers C1 and C2.

As illustrated in FIG. 5, wiring lines 32 and second electrodes 33 are provided on the front surface 3a of the counter substrate 3. Specifically, the wiring lines 32 are provided on the y1 side and the y2 side, respectively. The wiring lines 32 extend in the x direction. The second electrodes 33 are electrically coupled to the wiring lines 32. The second electrodes 33 extend in the y direction. The wiring lines 32 are provided with couplers C3 and C4. In the example illustrated in FIGS. 4 to 6, the number of the first electrodes 25 and the number of the second electrodes 33 are eight, but these numbers are schematic examples and are not necessarily the actual numbers of the first electrodes 25 and second electrodes 33. The number of the first electrodes 25 and the number of the second electrodes 33 only need to be two or more and thus may be nine or more.

As illustrated in FIGS. 6 and 7, the counter substrate 3 is disposed on the upper side relative to the array substrate 2 with a gap therebetween. The gap between the array substrate 2 and the counter substrate 3 is filled with the liquid crystal layer 4. The coupler C1 of the array substrate 2 and the coupler C3 of the counter substrate 3 are electrically coupled to each other through a conductive pillar (not illustrated). The coupler C2 of the array substrate 2 and the coupler C4 of the counter substrate 3 are electrically coupled to each other through a conductive pillar (not illustrated).

As illustrated in FIG. 6, the first terminal 101, the second terminal 102, the third terminal 103, the fourth terminal 104, the first pad 105, the second pad 106, the third pad 107, and the fourth pad 108 can be electrically coupled to the FPC 54 illustrated with dashed and double-dotted lines. For example, the liquid crystal panels 1 are each coupled to the D/A converter 64 through the individually provided FPC 54.

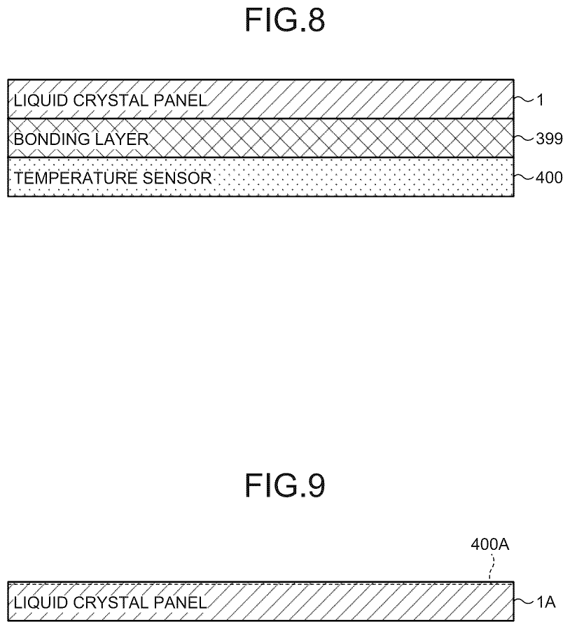

The light distributor 700 including the liquid crystal panels 1 described above with reference to FIGS. 3 to 7 functions as a component that adjusts the light distribution region of light externally emitted from the illumination device 50 by controlling the transmittance and transmission region of light passing through the liquid crystal panels 1. Control of the transmittance and transmission region of light passing through the liquid crystal panels 1 is achieved by control of potential provided to the first electrodes 25 and the second electrodes 33. With the potential control, the orientation of liquid crystal molecules included in the liquid crystal layer 4 is controlled, whereby the transmittance and transmission region of light passing through the liquid crystal panels 1 is controlled. Half of the four liquid crystal panels 1 arranged in the z direction, which are described above with reference to FIG. 2, are liquid crystal cells for p-wave polarization, and the other half are liquid crystal cells for s-wave polarization. Although not illustrated, one surface of the array substrate 2 and one surface of the counter substrate 3, which face each other with the liquid crystal layer 4 interposed therebetween, are provided with alignment films having different rubbing directions, respectively. The rubbing direction of the alignment film provided on the one surface of the array substrate 2 is, for example, the y direction. The rubbing direction of the alignment film provided on the one surface of the counter substrate 3 is, for example, the x direction. The following describes a specific example in which the temperature sensor 400 is provided on the liquid crystal panel 1 with reference to FIGS. 8 and 9.

FIG. 8 is a schematic diagram illustrating an example of mounting the temperature sensor 400 on the liquid crystal panel 1. As illustrated in FIG. 8, the liquid crystal panel 1 and the temperature sensor 400 are bonded to each other by a bonding layer 399. The bonding layer 399 is a sheet-type light-transmitting optical member with double-sided adhesive properties like optical clear adhesive (OCA). The method of mounting the temperature sensor 400 on the liquid crystal panel 1 is not limited to that using the bonding layer 399 but may be, for example, that using a bonding agent.

FIG. 9 is a schematic diagram illustrating an exemplary configuration of a temperature sensor 400A provided integrally with a liquid crystal panel 1A. The light distributor 700 may include, in place of the liquid crystal panel 1 having the temperature sensor 400 mounted thereon, the liquid crystal panel 1A integrally provided with the functions of the liquid crystal panel 1 and the functions of the temperature sensor 400 as illustrated in FIG. 9. In this case, the temperature sensor 400A functions in the same manner as the temperature sensor 400. The temperature sensor 400A is stacked together with the second electrodes 33 on the liquid crystal layer 4 side of the counter substrate 3 with, for example, an insulating layer interposed therebetween.

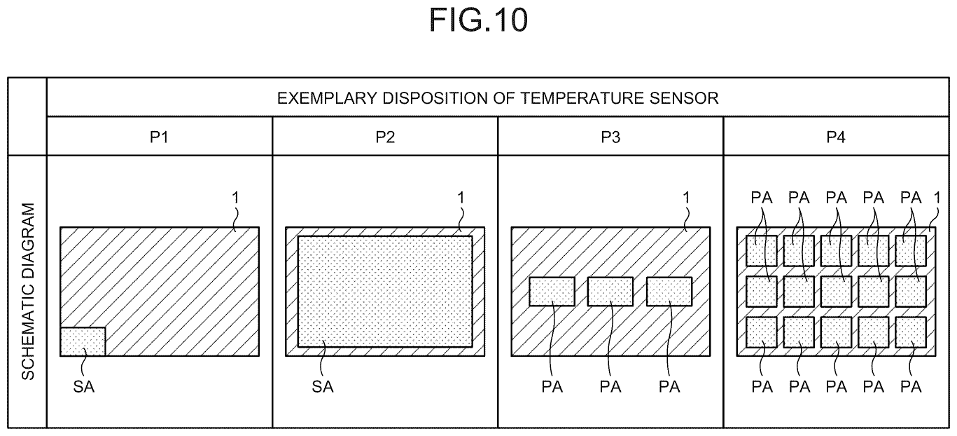

FIG. 10 is a schematic diagram illustrating exemplary acquisition regions of temperature information in the liquid crystal panel 1. In the following description, a temperature detection region SA and a partial temperature detection region PA are regions in which temperature information is acquired by the temperature sensor 400 or the temperature sensor 400A. For example, as in Example P1 in FIG. 10, the temperature detection region SA may be a region as a part of a plate surface of the rectangle-shaped liquid crystal panel 1, which is located near one of the four corners, or as in Example P2, the temperature detection region SA may be a region that covers most of the plate surface of the rectangle-shaped liquid crystal panel 1. Alternatively, as in Examples P3 and P4 in FIG. 10, a plurality of the partial temperature detection regions PA may be disposed in the plate surface of the rectangle-shaped liquid crystal panel 1.

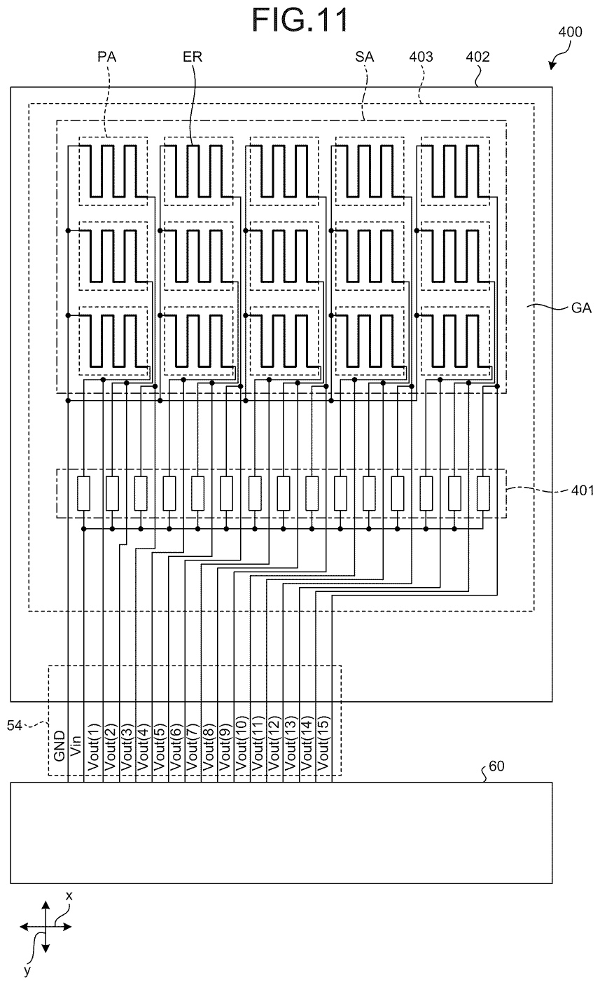

The temperature sensor 400 provided as a component corresponding to Example P4 in FIG. 10 will be described below with reference to FIG. 11.

FIG. 11 is a schematic diagram illustrating a main configuration of the temperature sensor 400 and a control device. As illustrated in FIG. 11, the temperature sensor 400 includes a sensor base member 402 and a sensor part 403.

The sensor base member 402 has the temperature detection region SA and a peripheral region GA. The temperature detection region SA includes a plurality of the partial temperature detection regions PA. The partial temperature detection regions PA are provided with a plurality of temperature detection resistance elements ER, respectively, included in the sensor part 403. The z direction is the normal direction of the sensor base member 402.

The temperature detection resistance elements ER are electric resistors made of a compound (metal compound) containing alloy and metal, or a metal. Each temperature detection resistance element ER may be a multilayered body obtained by stacking a plurality of kinds of materials each of which corresponds to at least one of metal, alloy, and metal compound. Alloy or the like in the description of the embodiment means a material that can be employed as a composition of each temperature detection resistance element ER. In the example illustrated in FIG. 11, each temperature detection resistance element ER has a configuration in which a plurality of L-shaped wiring lines with their long sides aligned with the y direction are coupled in the x direction. In this configuration, the plurality of L-shaped wiring lines are coupled to achieve the form of the temperature detection resistance element ER such that the short sides of two L-shaped wiring lines adjacent to each other in the x direction are staggered in the y direction.

The peripheral region GA is a region between the outer periphery of the temperature detection region SA and the end part of the sensor base member 402 and is a region in which the temperature detection resistance elements ER are not provided. A plurality of reference resistance elements 401 are provided in the peripheral region GA. The temperature sensor includes the temperature detection resistance elements ER provided in the partial temperature detection regions PA and the reference resistance elements 401 provided in the peripheral region GA.

The temperature detection resistance elements ER and the reference resistance elements 401 are coupled to wiring lines provided at the FPC 54. The wiring lines included in the FPC 54 are coupled to the system substrate 60. The wiring lines provided at the FPC 54 include a ground potential line GND, a signal input line Vin, and signal output lines Vout. The signal output lines Vout collectively denote signal output lines, such as signal output lines Vout (1), Vout (2), . . . , Vout (15), which are provided corresponding to the temperature detection resistance elements ER. The ground potential line GND illustrated in FIG. 11 is coupled to one end of each temperature detection resistance element ER. The ground potential line GND provides ground potential to each temperature detection resistance element ER. The signal input line Vin is coupled to one end of each reference resistance element 401. Each signal output line Vout is coupled to the other end of the corresponding temperature detection resistance element ER and the other end of the corresponding reference resistance element 401.

A drive signal of the temperature sensor 400 is input from the signal input line Vin. The drive signal is output to the signal output lines Vout through the temperature sensor 400. The strength of a signal output from each signal output line Vout varies with the temperature of the temperature detection resistance element ER coupled to the signal output line Vout. In other words, the temperature of each of the partial temperature detection regions PA provided with the temperature detection resistance elements ER can be detected based on a signal output from the corresponding signal output line Vout.

The number of electric resistance elements provided as the reference resistance elements 401 and the number of the signal output lines Vout correspond to the number of the temperature detection resistance elements ER. The plurality of electric resistance elements are coupled in parallel to one signal input line Vin. The example illustrated in FIG. 11 is a case of j=15 where j is the number of the temperature detection resistance elements ER. Signals corresponding to the temperatures of the 15 temperature detection resistance elements ER are output from the signal output lines Vout (1), Vout (2), . . . , Vout (15), respectively. The number of the temperature detection resistance elements ER is not limited to 15 and may be changed as appropriate. In addition, specific forms of the temperature sensor 400, such as wiring shapes of the temperature detection resistance elements ER, are not limited thereto and may be changed as appropriate.

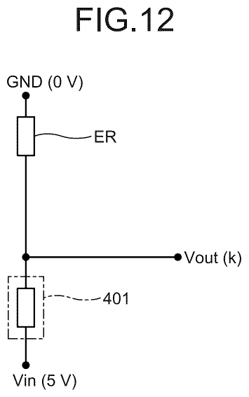

FIG. 12 is a diagram illustrating a voltage divider circuit including the temperature detection resistance element ER and the reference resistance element 401. Each temperature detection resistance element ER and the corresponding reference resistance element 401 described above with reference to FIG. 11 constitute the voltage divider circuit as illustrated in FIG. 12. The above-described signal output lines Vout (1), Vout (2), . . . , Vout (15) can be each regarded as an output line of the voltage divider circuit. Since each reference resistance element 401 has a fixed electric resistance value, an output from the signal output line Vout (k) of the voltage divider circuit depends on the electric resistance value of the temperature detection resistance element ER that functions as a variable resistor. The electric resistance value of the temperature detection resistance element ER corresponds to the temperature of the temperature detection resistance element ER. In other words, the magnitude of an output from the signal output line Vout (k) corresponds to temperature at a place where the temperature detection resistance element ER is provided. Thus, with the configuration in which the temperature sensor 400 including the temperature detection resistance elements ER is provided at the liquid crystal panel 1, information related to temperature at the place where the temperature detection resistance element ER is provided can be obtained based on an output from the corresponding signal output line Vout (k). Note that k is a natural number equal to or smaller than j.

In the embodiment, an integrated circuit (for example, an MCU 62 to be described later) performs software processing of converting an analog signal that is an output from the signal output line Vout (k) into a digital signal and deriving a temperature indicated by the digital signal, or circuit logic processing based on the same algorithm as the software processing. The integrated circuit and the configuration for the conversion from an analog signal into a digital signal may be provided as one component or separated components.

The description with reference to FIG. 11 is made on the configuration of the temperature sensor 400 corresponding to Example P4 in FIG. 10, but in a case where Example P3 in FIG. 10 is employed, the number of the partial temperature detection regions PA (temperature detection resistance elements ER) and the number of resistors provided as the reference resistance elements 401 in FIG. 11 are three, and accordingly, a configuration with j=3 is employed. In a case where Examples P1 and P2 in FIG. 10 are employed, the partial temperature detection region PA (temperature detection resistance element ER) provided in the temperature detection region SA in FIG. 11 is regarded as one variable resistor in the voltage divider circuit described above with reference to FIG. 12, one electric resistor is provided at the reference resistance element 401, and accordingly, a configuration with j=1 is employed. In a case where the temperature sensor 400A in FIG. 9 is employed, the sensor base member 402 of the temperature sensor 400 illustrated in FIG. 11 is replaced with a substrate (for example, the counter substrate 3) of the liquid crystal panel 1.

An output from each signal output line Vout (k) is transmitted to circuits provided on the system substrate 60 through the FPC 54. When, based on the output from the signal output line Vout (k), having obtained information indicating that temperature at a place where the corresponding temperature detection resistance element ER is provided, in other words, the temperature of the liquid crystal panel 1, is equal to or higher than a predetermined temperature, the MCU 62 of the system substrate 60 to be described later performs temperature increase suppression control. The temperature increase suppression control is operation control of the illumination device 50, which is performed to prevent or reduce further increase in the temperature of the liquid crystal panel 1.

A multiplexer may be provided on the signal output path for the signal from each signal output line Vout (k). By providing the multiplexer, it is possible to reduce the number of terminals through which a component (for example, the MCU 62) to receive outputs from the signal output lines Vout (k) receives the outputs. However, the component may be individually coupled to the signal output lines Vout (k).

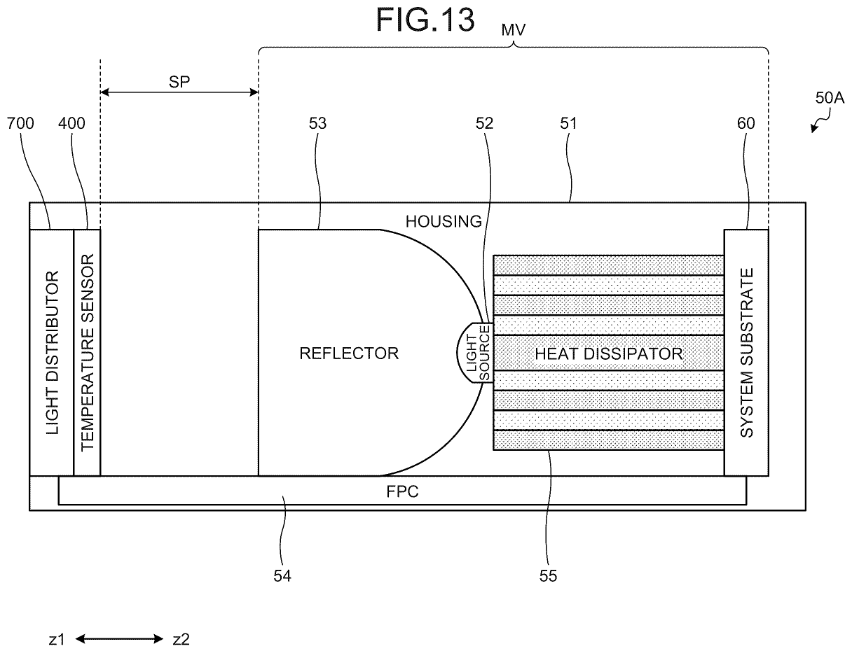

FIG. 13 is a schematic diagram illustrating exemplary operation control performed as the temperature increase suppression control. The above-described radiation heat from components provided on the z2 direction side relative to the light distributor 700 potentially rises the temperature of the liquid crystal panels 1 included in the light distributor 700. Thus, as illustrated in FIG. 13, the components are positioned farther away from the light distributor 700, thereby preventing or reducing further temperature increase of the liquid crystal panels 1 due to the radiation heat. In particular, as illustrated in FIG. 13, a space SP is provided between a base part MV and the light distributor 700 provided with the temperature sensor 400, thereby producing a cooling effect with inflow of external air into the space SP. Thus, the temperature of the liquid crystal panels 1 can be more easily decreased. The base part MV includes the light source 52, the reflector 53, the heat dissipator 55, and the system substrate 60.

Specifically, for example, one of the base part MV and the light distributor 700 provided with the temperature sensor 400 is provided to be movable in the z direction relative to the other part. More specifically, the one part is installed in the housing 51 with a guide member such as a straight movement rail. The one part is coupled to a driver (for example, a motor 552 to be described later) that operates to provide movement force in a straight movement direction. The driver operates to change the position of the one part in the z direction relative to the other part. Before the temperature of the liquid crystal panel 1 becomes equal to or higher than the predetermined temperature, no significantly large space such as the space SP is provided but the light distributor 700 provided with the temperature sensor 400 is in contact or closer to the reflector 53 as illustrated in FIG. 1. When having obtained information indicating that the temperature of the liquid crystal panel 1 has become equal to or higher than the predetermined temperature, the MCU 62 operates the driver so that the distance between the light distributor 700 provided with the temperature sensor 400 and the reflector 53 is increased.

The FPC 54 illustrated in FIGS. 1 and 13 includes wiring lines coupled to the liquid crystal panels 1 included in the light distributor 700, and also includes the ground potential line GND and the signal output line Vout (k) described above with reference to FIG. 11. The FPC 54 illustrated in FIG. 13 has a length that is sufficient for a positional relation when the space SP is formed between the base part MV and the light distributor 700 provided with the temperature sensor 400. The housing 51 is designed in advance to be able to house the components of the illumination device 50 other than the housing 51 even when the space SP has a maximum size. For example, in the case of a configuration in which one of the base part MV and the light distributor 700 provided with the temperature sensor 400 moves, the housing 51 has a predetermined extending length in the z direction as illustrated in FIG. 13. When the base part MV and the light distributor 700 provided with the temperature sensor 400 are closer to each other than in the example illustrated in FIG. 13, a space is generated on the z2 direction side relative to the base part MV or on the z1 direction side relative to the light distributor 700 provided with the temperature sensor 400.

The heat dissipator 55 includes at least one of a component that prevents or reduces temperature increase of the system substrate 60 and a component that operates for the temperature increase suppression control. Examples of the component that prevents or reduces temperature increase of the system substrate 60 include a heat sink provided between the light source 52 and the system substrate 60, and a fan 551 to be described later. The component that operates for the temperature increase suppression control is, for example, the above-described driver but not limited thereto and may be changed as appropriate.

The heat sink provided between the light source 52 and the system substrate 60 enhances radiation of heat emitted by at least one of the light source 52 and the system substrate 60. Specifically, the heat sink contacts at least one of a circuit included in the light source 52 or the outer peripheral surface of the housing of the light source 52, and a circuit provided on the system substrate 60. In a case where the fan 551 and the heat sink are both provided, the shape of the heat sink and disposition of the heat sink and the fan 551 are desirably designed so that airflow generated by operation of the fan 551 more efficiently cools the heat sink.

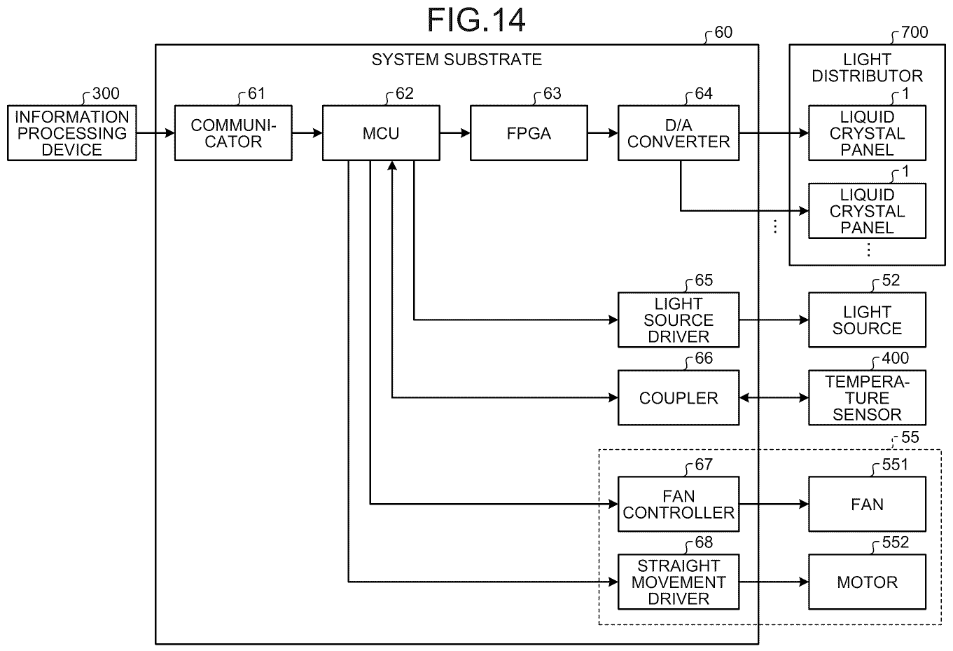

FIG. 14 is a block diagram illustrating an exemplary main configuration of the system substrate 60. The system substrate 60 is provided with, for example, a communicator 61, a micro controller unit (MCU) 62, a field programmable gate array (FPGA) 63, a digital-to-analog (D/A) converter 64, a light source driver 65, a coupler 66, a fan controller 67, and a straight movement driver 68.

The communicator 61 performs communication with an external information processing device 300. Specifically, the communicator 61 includes, for example, a circuit that functions as a network interface controller (NIC). The communicator 61 receives a signal transmitted from the information processing device 300 and including a command related to operation of the illumination device 50 and outputs information indicating the command to the MCU 62. The information processing device 300 is a portable terminal device such as a smartphone but not limited thereto. The information processing device 300 may be a stationary information processing device such as a server or a personal computer (PC) provided for control of the illumination device 50 or may be an information processing device in another form not exemplarily described herein.

The command related to the operation of the illumination device 50 and transmitted from the information processing device 300 is a command that specifies ON/OFF of light emission by the illumination device 50, a light emission region, light intensity, or the like. The command, however, is not limited thereto and may include anything that can be individually specified within an operation control range of the illumination device 50.

The MCU 62 outputs various signals to the FPGA 63, the light source driver 65, and the coupler 66 in accordance with the command related to the operation of the illumination device 50 and obtained from the information processing device 300 through the communicator 61. In other words, the MCU 62 controls various components included in the illumination device 50 so that the illumination device 50 operates in accordance with the command from the information processing device 300.

As described above, the MCU 62 acquires an output from each signal output line Vout (k) and performs the temperature increase suppression control in a case where the output indicates that the temperature of the liquid crystal panel 1 has become equal to or higher than the predetermined temperature.

Under control by the MCU 62, the FPGA 63 performs information processing for controlling the operation of the light distributor 700 and outputs a signal indicating a result of the information processing to the D/A converter 64. For example, in a case where designation related to a light emission region is included in the command related to the operation of the illumination device 50 and transmitted from the information processing device 300, the FPGA 63 performs information processing for operating the light distributor 700 so that light is emitted to the emission region corresponding to the designation.

The D/A converter 64 has a configuration that outputs, based on a digital signal that is a signal from the FPGA 63, an analog signal for operating a plurality of liquid crystal panels 1 included in the light distributor 700. The configuration may be made up of one circuit or may include a plurality of circuits.

The light source driver 65 is a controller that performs, under control by the MCU 62, ON/OFF control of the light source 52 and light emission intensity control when the light source 52 is ON. The controller may be made up of one circuit or may include a plurality of circuits.

The coupler 66 is an interface through which the MCU 62 is coupled to inputs and outputs (the ground potential line GND, the signal input line Vin, and the signal output lines Vout described above) of the temperature sensor 400 (or the temperature sensor 400A). The coupler 66 is coupled to the MCU 62 and interposed on a signal transmission path between the MCU 62 and the temperature sensor 400. The following description related to the temperature sensor 400 is also applicable to the temperature sensor 400A unless otherwise stated.

The fan controller 67 is a controller that performs ON/OFF control of the fan 551 and control of rotation speed per unit time (rpm) when the fan 551 is ON. The fan controller 67 controls the rotation speed per unit time (rpm) of the fan 551 by, for example, pulse width modulation (PWM) control. The controller may be made up of one circuit or may include a plurality of circuits.

The straight movement driver 68 is a controller that performs ON/OFF control of the motor 552, control of rotation speed (rpm) per unit time when the motor 552 is ON, and rotational direction control when the motor 552 is ON. The controller may be made up of one circuit or may include a plurality of circuits.

Although the fan 551 and the motor 552 are illustrated as components included in the heat dissipator 55 in FIG. 14, at least one of the fan 551 and the motor 552 may be omitted. In a case where the fan 551 and the motor 552 both are omitted, the above-described heat sink is a component included in the heat dissipator 55. In a case where the fan 551 is omitted, the fan controller 67 is omitted. In a case where the motor 552 is omitted, the straight movement driver 68 is omitted.

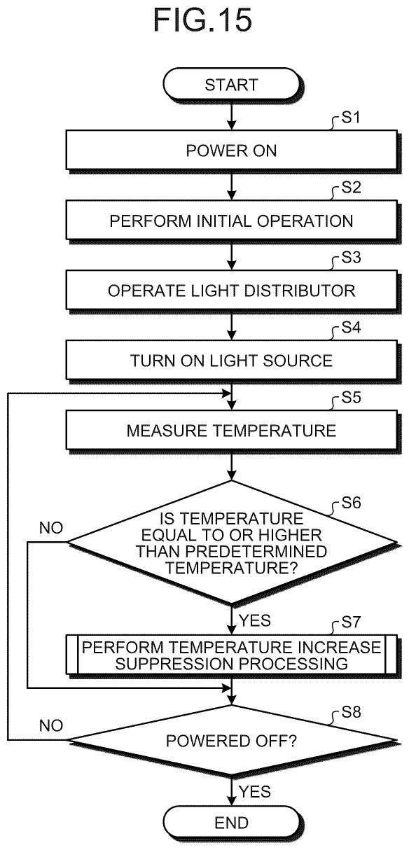

The processing related to the temperature increase suppression control will be described below with reference to FIGS. 15 to 20.

FIG. 15 is a flowchart of the operation processing of the illumination device 50. When the illumination device 50 is powered on (step S1), each component provided on the system substrate 60 performs initial operation (step S2). As a specific example, the MCU 62 performs processing corresponding to an operation mode (light emission intensity, light distribution region, and the like) designated by a signal transmitted from the information processing device 300 so that the illumination device 50 operates in the operation mode. The FPGA 63, the light source driver 65, and the like start operation under operation control by the MCU 62.

After the processing at step S2, the light distributor 700 operates (step S3), and the transmittance of light is controlled by the light distributor 700 so that light is incident in a light distribution region specified by the above-described operation mode. After the processing at step S3, the light source 52 is turned on (step S4).

Subsequently, temperature measurement is performed (step S5). Specifically, the MCU 62 operates the temperature sensor 400 and acquires information related to the temperature of the liquid crystal panel 1 by acquiring an output from each signal output line Vout (k). Note that data indicating the correspondence relation between the magnitude of an output from each signal output line Vout (k) and the temperature of the liquid crystal panel 1 provided with the temperature sensor 400 is obtained by experiment or the like in advance and held by the MCU 62.

The MCU 62 determines whether temperature equal to or higher than the predetermined temperature is measured in the processing at step S5 (step S6). When temperature equal to or higher than the predetermined temperature is measured (Yes at step S6), the MCU 62 performs temperature increase suppression processing (step S7).

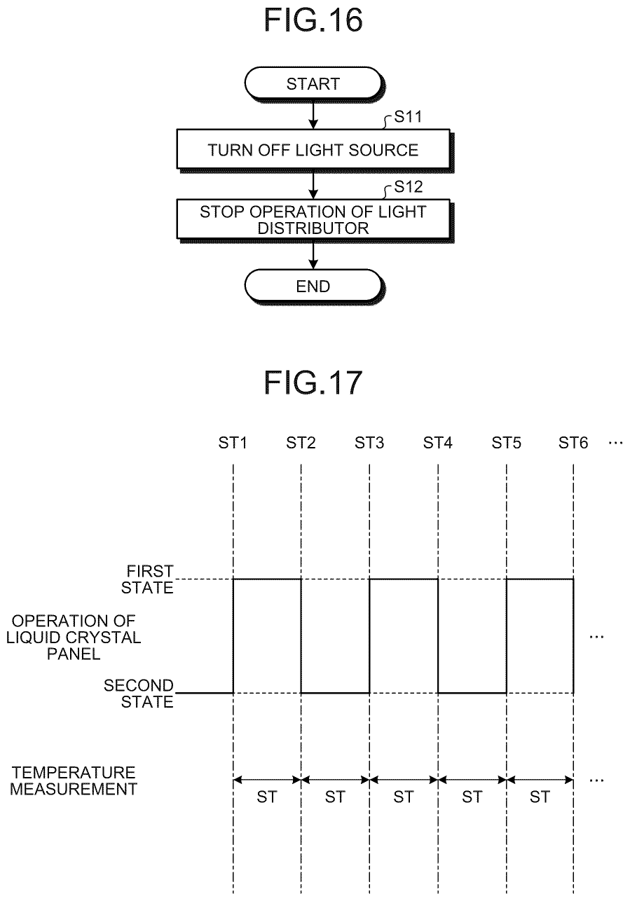

The temperature increase suppression processing is not limited to the processing of forming the space SP described above with reference to FIG. 13. For example, processing of turning off the light source 52 may be employed as the temperature increase suppression processing because it is possible, by turning off the light source 52, to prevent the liquid crystal panels 1 from being further heated by radiation heat from the light source 52. The following describes a case where processing of turning off the light source 52 is employed as the temperature increase suppression processing with reference to FIG. 16.

FIG. 16 is a flowchart of an exemplary process of the temperature increase suppression processing (step S7) illustrated in FIG. 15. First, the light source driver 65 turns off the light source 52 under control by the MCU 62 (step S11). After the processing at step S11, operation of the light distributor 700 is stopped through the FPGA 63 and the D/A converter 64 under control by the MCU 62 (step S12). In other words, the stop of the operation of the light distributor 700 is the stop of the operation of the plurality of liquid crystal panels 1 included in the light distributor 700.

After the temperature increase suppression processing (step S7) illustrated in FIG. 15, the process proceeds to the processing at step S5 again unless the illumination device 50 is powered off (No at step S8). When the illumination device 50 is powered off (Yes at step S8), operation of the illumination device 50 ends. When temperature equal to or higher than the predetermined temperature is not measured in the processing at step S5 (No at step S6), the processing at step S7 is not performed and the process proceeds to the bifurcation at step S8.

The execution period of step S5 described above with reference to FIG. 15, in other words, temperature measurement period is not the entire operation period of the illumination device 50 after the processing at step S4. The following describes the temperature measurement period with reference to FIG. 17.

FIG. 17 is a time chart illustrating the relation between operation of the liquid crystal panel 1 and the temperature measurement period. The potential of one of electrodes adjacent to each other among a plurality of electrodes (for example, the second electrodes 33 or the first electrodes 25) included in the liquid crystal panel 1 and arranged in the x direction (or the y direction) is 0 volt (V) and the potential of the other electrode exceeds 0 volt (V), whereby influence of the electric field caused by potential difference between the two adjacent electrodes is provided to the liquid crystal layer 4. The potentials provided to the two adjacent electrodes are periodically changed. Specifically, a first state in which one of the potentials is 0 volt (V) and the other exceeds 0 volt (V) and a second state in which the one exceeds 0 volt (V) and the other is 0 volt (V) are periodically switched. In the time chart exemplarily illustrating operation of the liquid crystal panel 1 in FIG. 17, the potential state is switched from the second state to the first state at switching timings ST1, ST3, and ST5, and is switched from the first state to the second state at switching timings ST2, ST4, and ST6. FIG. 17 illustrates only switching timings ST1, . . . , ST6 among the timings of switching between the first and second states, but in reality, the same switching timings periodically are provided thereafter as long as the illumination device 50 is in operation.

The temperature measurement period in which temperature is measured by operation of the temperature sensor 400 is set so as not to overlap the timings of switching between the first and second states. Specifically, temperature measurement is performed in each period ST illustrated in FIG. 17. Thus, it is possible to prevent decrease of temperature measurement accuracy due to influence of electric noise that can occur at the timings of switching between the first and second states.

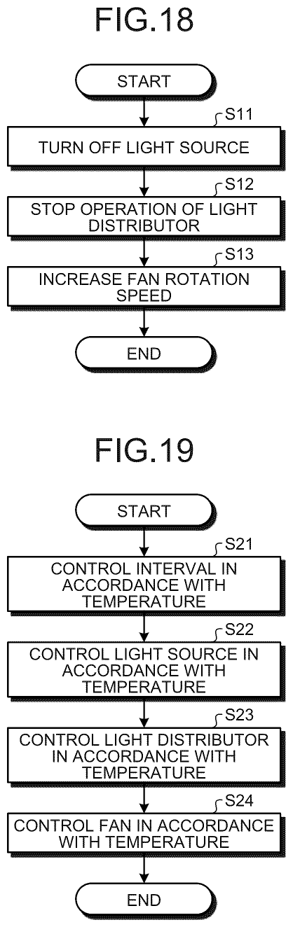

Although FIG. 16 exemplarily illustrates a case where processing of turning off the light source 52 is employed as the temperature increase suppression processing, the following describes, with reference to FIG. 18, a case where processing of enhancing cooling (air cooling) performance through operation of the fan 551 is additionally performed as the temperature increase suppression processing.

FIG. 18 is a flowchart of an exemplary process of the temperature increase suppression processing (step S7) illustrated in FIG. 15. In the example illustrated in FIG. 18, processing of increasing the rotation speed of the fan 551 is performed in addition to the processing at step S11 and the processing at step S12 described above with reference to FIG. 16 (step S13). In the processing at step S13, the fan controller 67 increases the rotation speed (rpm) of the fan 551 under control by the MCU 62. An increase in the rotation speed (rpm) here means that the rotation speed (rpm) of the fan 551 needs to be increased during the period when the temperature increase suppression processing is being performed as compared to during the period when the temperature increase suppression processing is not being performed. For example, the increase in the rotation speed may be such that the fan 551 does not rotate in the period in which the temperature increase suppression processing is not performed but the fan 551 rotates in the period in which the temperature increase suppression processing is being performed. Alternatively, the increase in the rotation speed may be such that the fan 551 rotates at predetermined rotation speed (rpm) in the period in which the temperature increase suppression processing is not performed and the fan 551 rotates at rotation speed (rpm) exceeding the predetermined rotation speed in the period in which the temperature increase suppression processing is being performed. The processing at step S13, the processing at step S11, and the processing at step S12 may be performed in any order. The processing at step S13 may be performed in parallel with the processing at step S11 and the processing at step S12.

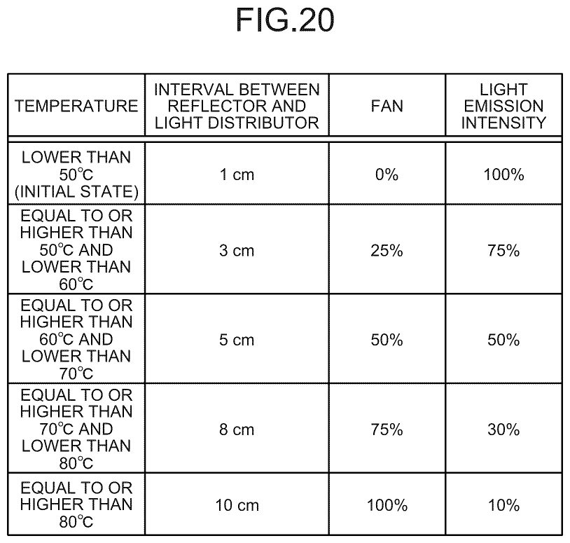

Note that the predetermined temperature is, for example, a temperature that interferes with operation of the liquid crystal panel 1 or a temperature that potentially interferes with operation of the liquid crystal panel 1 when the temperature of the liquid crystal panel increases further, and is determined based on consideration of operation of the liquid crystal panel 1. Specifically, the temperature that potentially interferes with operation of the liquid crystal panel 1 is, for example, 90° C., but the temperature increase suppression processing may be started at a stage where the temperature (for example, 50° C.) is yet lower than 90° C. Moreover, when the temperature of the liquid crystal panel 1 further increases after starting the temperature increase suppression processing, control may be performed to further increase the degree of temperature increase suppression of the liquid crystal panel 1 by the temperature increase suppression processing and the degree of cooling of components included in the illumination device 50. The following describes the process of operation based on the assumption of such a case with reference to FIGS. 19 and 20.

FIG. 19 is a flowchart of an exemplary process of the temperature increase suppression processing (step S7) illustrated in FIG. 15. In the example illustrated in FIG. 19, control of the space SP in accordance with the temperature measured in the processing at step S5 (step S21), control of the light source 52 in accordance with the temperature measured in the processing at step S5 (step S22), control of the light distributor 700 in accordance with the temperature measured in the processing at step S5 (step S23), and control of the fan 551 in accordance with the temperature measured in the processing at step S5 (step S24) are performed.

FIG. 20 is a table indicating an exemplary correspondence relation between the temperature measured in the processing at step S5, the space SP between the reflector 53 and the light distributor 700 provided with the temperature sensor 400, the rotation speed of the fan 551, and the light emission intensity of the light source 52. In a case where the predetermined temperature is 50° C., the temperature increase suppression processing is not performed during a period in which temperature lower than 50° C. is measured. For example, in an initial state in which the temperature increase suppression processing is not performed, the space SP is one centimeter (cm), the fan rotation speed (rpm) is 0 percent (%) of maximum rotation speed, and the light emission intensity of the light source 52 is highest (100%) as illustrated in FIG. 20. In a case where the temperature equal to or higher than 50° C. and lower than 60° C. is measured in the processing at step S5, the space SP may be set to three centimeters (cm) in the processing at step S21, the fan rotation speed (rpm) may be set to 25 percent (%) of the maximum rotation speed in the processing at step S24, and the light emission intensity of the light source 52 may be set to 75% of the highest intensity in the processing at step S22. In a case where the temperature equal to or higher than 60° C. and lower than 70° C. is measured in the processing at step S5, the space SP may be set to five centimeters (cm) in the processing at step S21, the fan rotation speed (rpm) may be set to 50 percent (%) of the maximum rotation speed in the processing at step S24, and the light emission intensity of the light source 52 may be set to 50% of the highest intensity in the processing at step S22. In a case where the temperature equal to or higher than 70° C. and lower than 80° C. is measured in the processing at step S5, the space SP may be set to eight centimeters (cm) in the processing at step S21, the fan rotation speed (rpm) may be set to 75 percent (%) of the maximum rotation speed in the processing at step S24, and the light emission intensity of the light source 52 may be set to 25% of the highest intensity in the processing at step S22. In a case where the temperature equal to or higher than 80° C. is measured in the processing at step S5, the space SP may be set to 10 centimeter (cm) in the processing at step S21, the fan rotation speed (rpm) may be set to the maximum rotation speed (100%) in the processing at step S24, and the light emission intensity of the light source 52 may be set to 10% in the processing at step S23.

As for control of the light distributor 700 in the processing at step S23, in other words, control of the plurality of liquid crystal panels 1 included in the light distributor 700, when the temperature is lower than 80° C., the liquid crystal panels 1 may be operated to increase the transmittance of light therethrough as much as possible to even slightly compensate illuminance decrease along with expansion of the space SP and reduction of the light emission intensity of the light source 52 due to the temperature increase suppression processing. The transmittance of light through the liquid crystal panels 1 may be increased in stages in the same manner as in the control of the space SP and the light emission intensity in stages in accordance with the temperature in FIG. 20.

Although the description with reference to FIGS. 19 and 20 is made on an exemplary case where the space SP is controlled step by step in accordance with the temperature measured in the processing at step S5, control of the space SP is not limited to such step-by-step control. For example, the reflector 53 and the light distributor 700 provided with the temperature sensor 400 may be controlled to be in contact with each other as illustrated in FIG. 1 when the temperature increase suppression processing is not performed, and the space SP may be formed between the reflector 53 and the light distributor 700 provided with the temperature sensor 400 as illustrated in FIG. 13 when the temperature increase suppression processing is performed. In a case where processing of changing the space SP is performed as the temperature increase suppression processing, at least one of the control of the rotation speed of the fan 551 and the control of the light emission intensity of the light source 52 may be omitted. In a case where the control of the rotation speed of the fan 551 is performed as the temperature increase suppression processing, at least one of the control of the light emission intensity of the light source 52 and the control of the space SP may be omitted. In a case where the control of the light emission intensity of the light source 52 is performed as the temperature increase suppression processing, at least one of the control of the rotation speed of the fan 551 and the control of the space SP may be omitted.

As described above, according to the embodiment, an illumination device (illumination device 50) includes a light source (light source 52) configured to emit light, a light distributor (light distributor 700) including a liquid crystal panel (liquid crystal panel 1) and configured to adjust the light distribution region of light externally emitted from the light source by controlling the transmittance and transmission region of light passing through the liquid crystal panel, a temperature information acquirer (temperature sensor 400) configured to acquire information indicating the temperature of the light distributor, and a controller (MCU 62) configured to perform predetermined operation (the temperature increase suppression processing) for preventing or reducing increase in the temperature of the light distributor when the temperature of the light distributor is equal to or higher than a predetermined temperature. With the predetermined operation, it is possible to prevent or reduce further temperature increase of the liquid crystal panel included in the light distributor the temperature of which has become equal to or higher than the predetermined temperature.

The predetermined operation (temperature increase suppression processing) for preventing or reducing increase in the temperature of the light distributor when the temperature of the light distributor (light distributor 700) is equal to or higher than the predetermined temperature includes turning-off of the light source (light source 52). Accordingly, it is possible to prevent or reduce increase in the temperature of the liquid crystal panel included in the light distributor due to radiation heat along with turning-on of the light source.

The illumination device (illumination device 50) further includes a fan (fan 551) configured to generate airflow that cools at least one of the light source (light source 52) and the controller (MCU 62). The predetermined operation (temperature increase suppression processing) for preventing or reducing increase in the temperature of the light distributor when the temperature of the light distributor (light distributor 700) is equal to or higher than the predetermined temperature includes operation of the fan not in operation or increase of the rotation speed per unit time (rpm) of the fan in operation. Accordingly, it is possible to enhance cooling with airflow generated by the fan, thereby preventing or reducing increase in the temperature of the liquid crystal panel included in the light distributor.

The illumination device (illumination device 50) further includes a driver (motor 552) configured to operate to change the distance between the light source (light source 52) and the light distributor (light distributor 700). The predetermined operation (temperature increase suppression processing) for preventing or reducing increase in the temperature of the light distributor when the temperature of the light distributor is equal to or higher than the predetermined temperature includes increasing the distance between the light source and the light distributor. Accordingly, it is possible to prevent or reduce increase in the temperature of the liquid crystal panel included in the light distributor due to radiation heat along with turning-on of the light source.

Inversion drive is applied to the liquid crystal panel (liquid crystal panel 1), in which the magnitude relation between potentials of adjacent electrodes (between the first electrodes 25 or between the second electrodes 33) is periodically switched. The acquisition period (period ST) of the information indicating the temperature of the light distributor (light distributor 700) does not include timings (switching timings ST1, . . . , ST6) at which the magnitude relation between the potentials is switched. Accordingly, it is possible to prevent decrease of temperature measurement accuracy due to influence of electric noise that can occur at the switching timings of the magnitude relation between the potentials.

The configuration of the above-described embodiment is an example in a case where the temperature information acquirer included in the illumination device 50 is the temperature sensor 400, but a sensor configured to acquire information indicating the temperature of a component of the illumination device 50 may be additionally provided. As a specific example, any of temperature sensors 451, 452, 453, and 454 illustrated in FIG. 1 may be provided. The temperature sensor 451 is provided at a position in the FPC 54 extremely close to the light distributor 700. The temperature sensor 451 can function in an extremely similar manner to the temperature sensor 400, and thus in a case where the temperature sensor 451 is disposed, the temperature sensor 400 may be omitted and temperature measured by the temperature sensor 451 may be regarded as the temperature of the liquid crystal panel 1 included in the light distributor 700. The temperature sensor 452 is provided at a position in contact with or close to the light source 52. Radiation heat from the light source 52 is a cause of temperature increase of the liquid crystal panel 1 included in the light distributor 700, and thus acquisition of information related to the temperature of the light source 52 makes it easier to take actions such as execution of the temperature increase suppression processing as preliminary operation for preventing or reducing temperature increase of the liquid crystal panel 1. The temperature sensor 453 is provided at a position in contact with or close to a circuit provided on the system substrate 60. Radiation heat from the circuit provided on the system substrate 60 is a cause of temperature increase of the liquid crystal panel 1 included in the light distributor 700, and thus acquisition of information related to the temperature of the circuit makes it easier to take actions such as execution of the temperature increase suppression processing as preliminary operation for preventing or reducing temperature increase of the liquid crystal panel 1. The temperature sensor 454 is provided at the housing 51. The temperature of the housing 51 being high enough to be equal to or higher than the predetermined temperature or close to the predetermined temperature indicates further increase in the degree of difficulty in cooling the liquid crystal panel 1 included in the light distributor 700. Thus, acquisition of information related to the temperature of the housing 51 makes it easier to take actions such as execution of the temperature increase suppression processing as preliminary operation for preventing or reducing temperature increase of the liquid crystal panel 1.

Predetermined temperatures, various percentage values, and specific sizes of the space SP exemplarily illustrated in FIG. 20 are merely exemplary and the present disclosure is not limited thereto, and thus these numerical values may be changed as appropriate. However, these numerical values are desirably determined so that the effect of preventing or reducing temperature increase of the light distributor 700 is enhanced as the temperature measured in the processing at step S5 increases.

Information on a threshold temperature to be set as a predetermined temperature is held by a component such as the MCU 62, which performs processing based on information that can be acquired from the temperature sensor 400, or is held by a storage device that can be referred to from the component. The condition “when temperature is equal to or higher than a predetermined temperature” may be changed to a condition “when temperature exceeds a predetermined temperature”. In either case, processing substantially the same as the above described processing can be performed by appropriately setting the predetermined temperature.

Moreover, the specific structure of the light distributor 700 is not limited to the example described above with reference to FIG. 8. For example, the light distributor 700 may include a liquid crystal panel that functions as what is called a liquid crystal lens provided to allow change of the refraction degree of light traveling from one surface side toward the other surface side by light distribution control of liquid crystals.

Other effects that are achieved by aspects described above in the present embodiment and obvious from description of the present specification or can be thought of by the skilled person in the art as appropriate should be considered as effects achieved by the present disclosure.

What is claimed is:

1. An illumination device comprising:
a light source configured to emit light;
a light distributor including a liquid crystal panel and configured to adjust a light distribution region of light externally emitted from the light source by controlling transmittance and a transmission region of light passing through the liquid crystal panel;
a temperature information acquirer configured to acquire information indicating temperature of the light distributor; and
a controller configured to perform predetermined operation for preventing or reducing increase in the temperature of the light distributor when the temperature of the light distributor is equal to or higher than a predetermined temperature.

2. The illumination device according to claim 1, wherein the predetermined operation includes turning-off of the light source.

3. The illumination device according to claim 1, further comprising a fan configured to generate airflow that cools at least one of the light source and the controller, wherein
the predetermined operation includes operation of the fan not in operation or increase of rotation speed per unit time of the fan in operation.

4. The illumination device according to claim 1, further comprising a driver configured to operate to change distance between the light source and the light distributor, wherein
the predetermined operation includes increasing a distance between the light source and the light distributor.

5. The illumination device according to claim 1, wherein
inversion drive is applied to the liquid crystal panel, in which magnitude relation between potentials of adjacent electrodes is periodically switched, and
an acquisition period of the information does not include timings at which the magnitude relation of the potentials is switched.
